(19) United States
(12) Patent Application Publication
(10) Pub. No.: US 2025/0181091 A1
(43) Pub. Date: Jun. 5, 2025

(54) VOLTAGE REGULATION SYSTEM WITH AN OVERSHOOT AND UNDERSHOOT REGULATION CIRCUIT

(71) Applicant: Himax Imaging Limited, Tainan City (TW)

(72) Inventors: Ghia-Ming Hong, Tainan City (TW); Ya-Sen Chang, Tainan City (TW); Puo-Tsang Huang, Tainan City (TW); Zheng-Zhi Huang, Tainan City (TW); Chen-Cheng-Hung Hung, Tainan City (TW)

(73) Assignee: Himax Imaging Limited, Tainan City (TW)

(21) Appl. No.: 18/525,867

(22) Filed: Dec. 1, 2023

(51) Int. Cl. G05F 1/56

(52) U.S. Cl. CPC G05F 1/56

(57) ABSTRACT

A voltage regulation system includes a voltage regulator and an undershoot/overshoot regulation circuit. The voltage regulator includes a gate node having a gate voltage and an output node having an output voltage. The undershoot/overshoot regulation circuit includes an inverse amplifier and a capacitor. The inverse amplifier has an output node for outputting a feedback voltage in response to the change of the output voltage. The capacitor has a first node coupled to the gate node and a second node coupled to the output node of the inverse amplifier.

### BACKGROUND OF THE INVENTION

### 1. Field of the Invention

The invention is related to a low dropout circuit, especially to a low dropout circuit with feedback.

### 2. Description of the Prior Art

Low dropout regulator (LDO), one kind of voltage regulator, also known as low dropout linear regulator, is a type of linear direct current (DC) regulator, which is used to provide stable DC voltage power supply. Compared with general linear DC regulators, low dropout regulators can operate with a smaller input-output voltage difference.

The potential difference between the input node and output node of the low dropout regulator (LDO) has not yet been specifically defined, but generally speaking, the minimum potential difference for a voltage regulator to operate steadily is less than 1V. Taking an integrated circuit (IC) with a 3.3V power supply as an example, the standard power supply cannot be reduced from 5V to 3.3V, so an LDO with a low potential difference between the input node and output node is necessary. In this way, using low potential difference operation can reduce energy loss and heat dissipation.

The operation speed of high speed input output (IO) circuits is getting faster and faster. Using an external LDO to stabilize the voltage source node of a high speed IO circuit requires external capacitors. However, an LDO without a capacitor is often used in an application. When using an LDO without a capacitor, the drain node current will cause voltage noise jitter.

### SUMMARY OF THE INVENTION

A voltage regulation system includes a voltage regulator and an undershoot/overshoot regulation circuit. The voltage regulator includes a gate node having a gate voltage and an output node having an output voltage. The undershoot/overshoot regulation circuit includes an inverse amplifier and a capacitor. The inverse amplifier has an output node for outputting a feedback voltage in response to the change of the output voltage. The capacitor has a first node coupled to the gate node and a second node coupled to the output node of the inverse amplifier.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a voltage regulation system including a voltage regulator and an undershoot/overshoot regulation circuit according to an embodiment of the present invention

FIG. 2 is a voltage regulation system including a voltage regulator and an undershoot/overshoot regulation circuit according to another embodiment of the present invention.

FIG. 3 is a diagram of a pilot voltage versus time for simulation result of the voltage regulation system including the voltage regulator and the undershoot/overshoot regulation circuit in FIG. 1.

### DETAILED DESCRIPTION

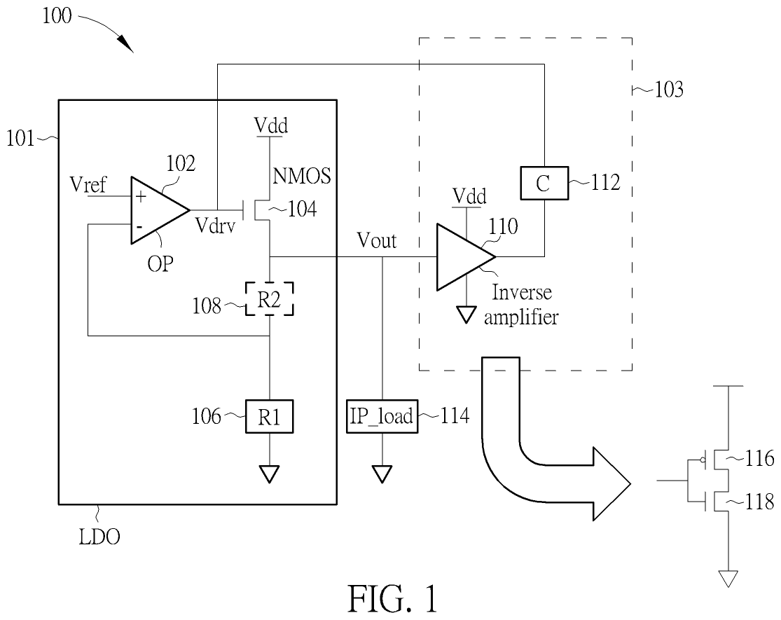

FIG. 1 is a voltage regulation system 100 including a voltage regulator 101 and an undershoot/overshoot regulation circuit 103 according to an embodiment of the present invention. In this embodiment of the present invention, the voltage regulator 101 may be a low dropout circuit (LDO) and has an output node and a gate node for outputting an output voltage and a gate voltage respectively. The voltage regulator 101 includes an operation amplifier 102, a transistor 104, a first resistor 106, and a second resistor 108. The undershoot/overshoot regulation circuit 103 includes an inverse amplifier 110 and a capacitor 112 in series connection. The undershoot/overshoot regulation circuit 103 is connected between the output node and the gate node of the voltage regulator 101.

The operation amplifier 102 includes a positive node configured to receive a reference voltage Vref, a negative node, and an output node. The transistor 104 (N-type) includes a gate node coupled to the output node of the operation amplifier 102 for receiving the get voltage Vdrv, a drain node configured to receive a supply voltage Vdd, and a source node (i.e., the output node) configured to output an output voltage Vout. A load circuit 114 can take the output voltage Vout as supply voltage. The first resistor 106 includes a first node coupled to the negative node of the operation amplifier 102, and a second node coupled to a ground. The second resistor 108 includes a first node coupled to the source node of the transistor 104, and a second node coupled to the first node of the first resistor 106 (i.e., the negative node of the operation amplifier 102).

The inverse amplifier 110 includes an input node coupled to the source node of the transistor 104, an output node for outputting a feedback voltage in response to the change of the output voltage of the voltage regulator 101, a power node configured to receive a supply voltage, and a ground node coupled to the ground. The capacitor 112 includes a first node coupled to the gate node of the transistor 104 (i.e., the output node of the operation amplifier 102), and a second node coupled to the output node of the inverse amplifier 110. It is noted that the second resistor 108 can be omitted (removed) in another embodiment. When the second resistor 108 is removed, the first node of the first resistor 106 is coupled to the source node of the transistor 104 and the negative node of the operation amplifier 102.

The inverse amplifier 110 further includes a P-type transistor 116, and an N-type transistor 118. The P-type transistor 116 includes a gate node coupled to the source node of the transistor 104, a source node configured to receive the supply voltage, and a drain node coupled to the second node of the capacitor 112. The N-type transistor 118 includes a gate node coupled to the source node of the transistor 104, a drain node coupled to the drain node of the P-type transistor 116, and a source node coupled to the ground.

By setting the inverse amplifier 110 in the voltage regulation system 100, the jitter in the output voltage Vout would feedback to the gate node of the transistor 104 through the inverse amplifier 110 and the capacitor 112 rapidly. Therefore, the jitter in the output voltage Vout can be reduced by the analog feedback circuit including the inverse amplifier 110 and the capacitor 112. Unlike digital circuit solution, the analog feedback circuit reacts to the jitter immediately to stabilize the voltage regulation system 100 and needs no control clock signals comparing to the digital manner.

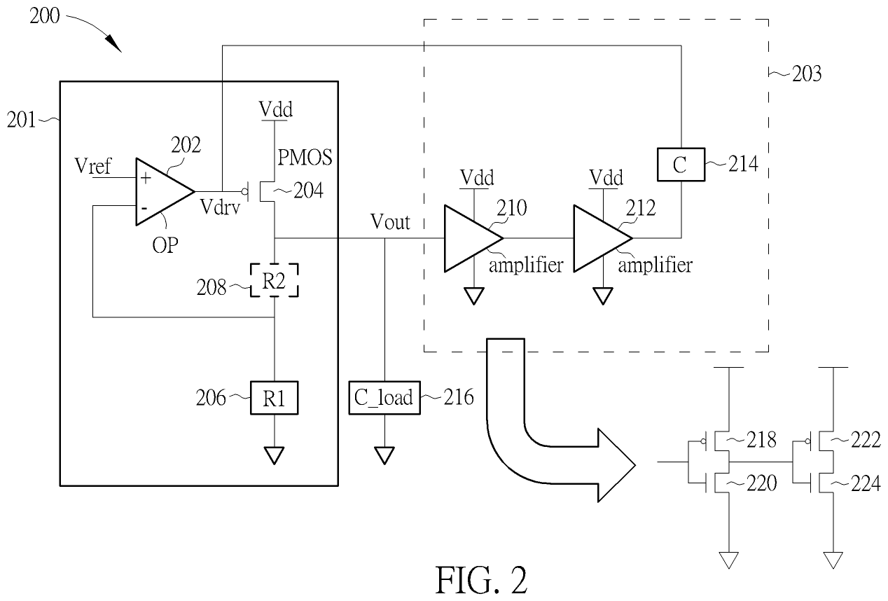

FIG. 2 is a voltage regulation system 200 including a voltage regulator 201 and an undershoot/overshoot regulation circuit 203 according to another embodiment of the present invention. In this embodiment of the present invention, the voltage regulator 201 may be a low dropout circuit (LDO) and has an output node and a gate node for outputting an output voltage and a gate voltage respectively. The voltage regulator 201 includes an operation amplifier 202, a transistor 204, a first resistor 206, and a second resistor 208. The undershoot/overshoot regulation circuit 203 includes a first inverse amplifier 210, a second inverse amplifier 212, a capacitor 214 in series connection. The undershoot/overshoot regulation circuit 203 is connected between the output node and the gate node of the voltage regulator 201.

The operation amplifier 202 includes a positive node configured to receive a reference voltage Vref, a negative node, and an output node to output a get voltage Vdrv. The transistor 204 includes a gate node coupled to the output node of the operation amplifier 202, a source node configured to receive a supply voltage Vdd, and a drain node configured to output an output voltage Vout. The first resistor 206 includes a first node coupled to the negative node of the operation amplifier 202, and a second node coupled to a ground. The second resistor 208 includes a first node coupled to the drain node of the transistor 204, and a second node coupled to the first node of the first resistor 206. The first inverse amplifier 210 includes an input node coupled to the drain node of the transistor 204 (i.e., the output node of the voltage regulator 201), an output node, a power node configured to receive a supply voltage, and a ground node coupled to the ground. The second inverse amplifier 212 includes an input node coupled to the output node of the first inverse amplifier 210, an output node for outputting a feedback voltage in response to the change of the output voltage of the voltage regulator 201, a power node configured to receive the supply voltage Vdd, and a ground node coupled to the ground. The capacitor 214 includes a first node coupled to the output node of the operation amplifier 202, and a second node coupled to the output node of the second inverse amplifier 212. The load 216 includes a first node coupled to the drain node of the transistor 204, and a second node coupled to the ground.

In an embodiment, the transistor 204 is a P-type transistor. The first inverse amplifier 210 further includes a first P-type transistor 218, and a first N-type transistor 220. The first P-type transistor 218 includes a gate node coupled to the drain node of the transistor 204, a source node configured to receive the supply voltage, and a drain node coupled to the input node of the second inverse amplifier 212. The first N-type transistor 220 includes a gate node coupled to the drain node of the transistor 204, a drain node coupled to the drain node of the first P-type transistor 218, and a source node coupled to the ground. The second inverse amplifier 212 further includes a second P-type transistor 222, and a second N-type transistor 224. The second P-type transistor 222 includes a gate node coupled to the output node of the first inverse amplifier 210, a source node configured to receive the supply voltage, and a drain node coupled to the second node of the capacitor 214. The second N-type transistor 224 includes a gate node coupled to the output node of the first inverse amplifier 210, a drain node coupled to the drain node of the second P-type transistor 222, and a source node coupled to the ground.

By setting the first inverse amplifier 210 and the second inverse amplifier 212 in the voltage regulation system 200, the jitter in output voltage Vout would feedback to the gate node of the transistor 204 through the first inverse amplifier 210, the second inverse amplifier 212 and the capacitor 214. Therefore, the jitter in the output voltage Vout can be reduced by the analog feedback circuit including the first inverse amplifier 210, the second inverse amplifier 212 and the capacitor 214. Unlike digital circuit solution, the analog feedback circuit reacts to the jitter immediately to stabilize the voltage regulation system 200.

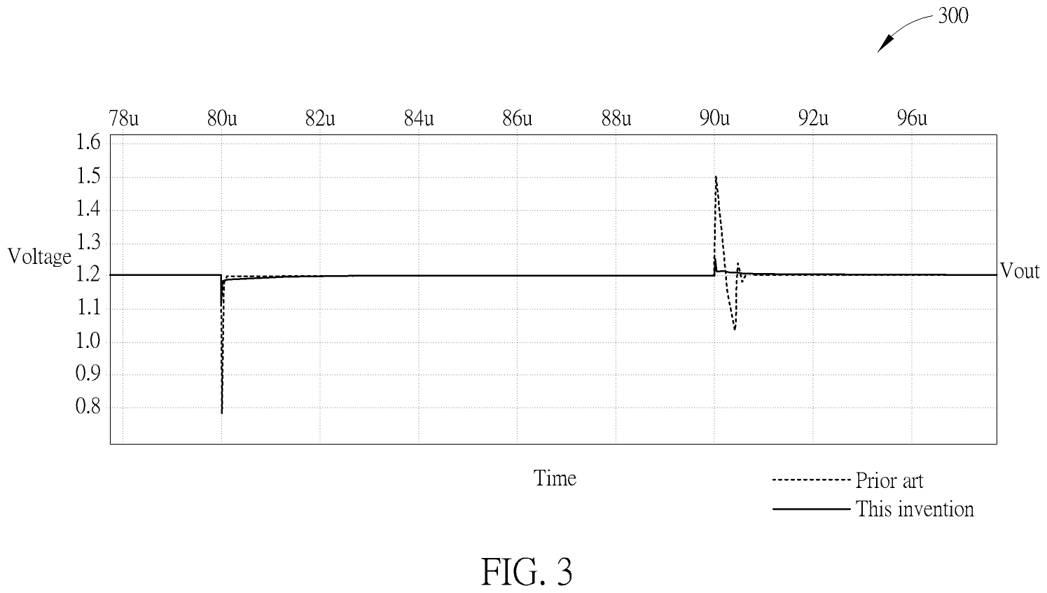

FIG. 3 is a simulation result 300 of the voltage regulation system 100 including the voltage regulator 101 and the undershoot/overshoot regulation circuit 103. The solid and dashed curves represent the output voltages-vs-time of the voltage regulation system 100 and a prior art voltage regulation system, respectively. The dashed line shows a significant jitter, and the solid line only exhibits a trivial jitter. The simulation result 300 shows that by using the voltage regulation system 100, the jitter in the output voltage can be significantly reduced. Moreover, the analog feedback circuit can react to the jitter immediately, the compensation is faster than using a digital feedback circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A voltage regulation system comprising:
a voltage regulator comprising a gate node having a gate voltage and an output node having an output voltage; and
an undershoot/overshoot regulation circuit comprising:
an inverse amplifier having a output node for outputting a feedback voltage in response to the change of the output voltage; and
a capacitor having a first node coupled to the gate node and a second node coupled to the output node of the inverse amplifier.

2. The voltage regulation system of claim 1, wherein the voltage regulator further comprises:
an operation amplifier, comprising:
a positive node configured to receive a reference voltage;
a negative node coupled to the output node of the voltage regulator; and
an output node coupled to the gate node;
a transistor, comprising:
the gate node;
a drain node configured to receive a supply voltage; and
a source node coupled to the output node of the voltage regulator; and
a first resistor, comprising:
a first node coupled to the negative node of the operation amplifier; and
a second node coupled to a ground.

3. The voltage regulation system of claim 1, wherein the voltage regulator further comprises:
an operation amplifier, comprising:
a positive node configured to receive a reference voltage;
a negative node; and
an output node coupled to the gate node;
a transistor, comprising:
the gate node;
a drain node configured to receive a supply voltage; and
a source node coupled to the output node of the voltage regulator;
a first resistor, comprising:
a first node coupled to the negative node of the operation amplifier; and
a second node coupled to a ground; and
a second resistor, comprising:
a first node coupled to the source node of the transistor; and
a second node coupled to the first node of the first resistor.

4. The voltage regulation system of claim 1, further comprising:
a load, comprising:
a first node coupled to the output node of the voltage regulator; and
a second node coupled to the ground.

5. The voltage regulation system of claim 1, wherein the transistor is an N-type transistor.

6. A voltage regulation system comprising:
a voltage regulator comprising a gate node having a gate voltage and an output node having an output voltage; and
an undershoot/overshoot regulation circuit comprising:
a first inverse amplifier, coupled to the output node, for receiving the output voltage;
a second inverse amplifier, coupled to an output node of the first inverse amplifier, having an output node for outputting a feedback voltage in response to the change of the output voltage; and
a capacitor having a first node coupled to the gate node and a second node coupled to the output node of the second inverse amplifier.

7. The voltage regulation system of claim 6, wherein the voltage regulator further comprises:
an operation amplifier, comprising:
a positive node configured to receive a reference voltage;
a negative node coupled to the output node of the voltage regulator; and
an output node coupled to the gate node;
a transistor, comprising:
the gate node;
a source node configured to receive a supply voltage; and
a drain node coupled to the output node of the voltage regulator; and
a first resistor, comprising:
a first node coupled to the negative node of the operation amplifier; and
a second node coupled to a ground.

8. The voltage regulation system of claim 6, wherein the voltage regulator further comprising:
an operation amplifier, comprising:
a positive node configured to receive a reference voltage;
a negative node; and
an output node coupled to the gate node;
a transistor, comprising:
the gate node;
a source node configured to receive a supply voltage; and
a drain node coupled to the output node of the voltage regulator;
a first resistor, comprising:
a first node coupled to the negative node of the operation amplifier; and
a second node coupled to a ground; and
a second resistor, comprising:
a first node coupled to the drain node of the transistor; and
a second node coupled to the first node of the first resistor.

9. The voltage regulation system of claim 6, further comprising:
a load, comprising:
a first node coupled to the output node of the voltage regulator; and
a second node coupled to the ground.

10. The voltage regulation system of claim 6, wherein the transistor is a P-type transistor.
